(19) United States
(12) Patent Application Publication
(10) Pub. No.: US 2021/0242462 A1
(43) Pub. Date: Aug. 5, 2021

(54) Method of Manufacturing Biomass Hard Carbon for Negative Electrode of Sodium-ion Batteries and Sodium-ion Batteries Containing Biomass Hard Carbon Thereof

(71) Applicant: CPC Corporation, Taiwan, Kaohsiung (TW)

(72) Inventors: Tzu-Hsien Hsieh, Kaohsiung (TW); Haw-Yeu Chuang, Kaohsiung (TW); Yang-Chuang Chang, Kaohsiung (TW); Wei-Jen Liu, Kaohsiung (TW); Rasu Muruganantham, Taoyuan City (TW)

(21) Appl. No.: 16/833,889

(22) Filed: Mar. 30, 2020

(30) Foreign Application Priority Data
Feb. 4, 2020 (TW) 109103426

(51) Int. Cl. H01M 4/583; H01M 10/054; C01B 32/05

(52) U.S. Cl. CPC H01M 4/583; H01M 2004/027; C01B 32/05; H01M 10/054

(57) ABSTRACT

A method of manufacturing biomass hard carbon contains: step 1: mixing a carbon source and a nanoscale powder so as to obtain a precursor; step 2: disposing the precursor in an oxygen-free environment; step 3: carbonizing the precursor by a heating process so as to make the precursor be transformed into a hard carbon mixture; step 4: rinsing the hard carbon mixture by an acid solution, such that the hard carbon mixture has a pH value less than 0.5; step 5: modulating the pH value to be greater than 6 by using a pure water to rinse the hard carbon mixture; and step 6: producing a biomass hard carbon by drying the hard carbon mixture.

### BACKGROUND OF THE INVENTION

### 1. Field of the Invention

The present invention relates to the technology field of carbon negative electrode materials, and more particularly to a biomass hard carbon that is suitable for use in fabrication of a negative electrode of a sodium-ion battery.

### 2. Description of the Prior Art

With the well development of science and technology, various energy storage devices are all demanded to show an excellent capacity performance. Accordingly, how to develop and provide an electricity storage device with high capacity performance hence becomes an important issue.

Hard carbon is a novel material having electrochemical activity, and is suitable for use in manufacture of a lithium ion battery or a negative electrode of a sodium ion battery. Experimental results have reported that, the batteries using the hard carbon material commonly show advantages of steady structure, fast charge and discharge rate capability and long battery life.

In conventional, the negative electrode is made of a carbon material. However, manufacturing process of the carbon material is complex, and it needs to synthesize a high cost precursor for making the carbon material during the manufacturing process. Moreover, there are a variety of special material used in the manufacturing process, including: polymers, phenolics, aldehydes, acid catalysts, etc.

Nowadays, there is much attention paid on issues of carbon emissions responsibility within a circular economy. Therefore, how to develop a simple method for producing a hard carbon material with advantages of increasing reversible specific capacity, electrical conductivity of battery, low manufacturing cost, and keeping environmental protection hence become the most important issue.

### SUMMARY OF THE INVENTION

The primary objective of the present invention is to disclose a method of manufacturing a high electrical conductivity and environmental protection biomass hard carbon. The biomass hard carbon is suitable for use in fabrication of a negative electrode of a sodium-ion battery.

In order to achieve the forgoing primary objective, the present invention provides an embodiment for the method of manufacturing the biomass hard carbon, comprising:
(1) mixing a carbon source and a nanoscale powder so as to obtain a precursor;
(2) disposing the precursor in an oxygen-free environment;
(3) carbonizing the precursor by a heating process, so as to make the precursor be transformed into a hard carbon mixture;
(4) rinsing the hard carbon mixture by an acid solution, such that the hard carbon mixture has a pH value less than 0.5;
(5) modulating the pH value to be greater than 6 by using a pure water to rinse the hard carbon mixture; and
(6) producing a biomass hard carbon by drying the hard carbon mixture.

In one embodiment of the forgoing method, the carbon source is selected from the group consisting of cracked oil and coke oil.

In one embodiment of the forgoing method, the carbon source is obtained by applying a thermochemical conversion process to a bio-waste, and the thermochemical conversion process is selected from the group consisting of carbonizing process, pyrolysis process and gasifying process.

In one embodiment of the forgoing method, the nanoscale power is material that is selected from the group consisting of calcium carbonate, zinc oxide, iron oxide, calcium phosphate, and a combination of the forgoing two or more materials.

In one embodiment of the forgoing method, the nanoscale power comprising a plurality of nanoparticles having a particle size in a range between 20 nm and 80 nm.

In one embodiment of the forgoing method, the nanoscale power in the precursor has a weight percent in a range between 0 and 50.

In one embodiment of the forgoing method, the heating process in the step 3 comprises a first heating stage and a second heating stage, such that the precursor is treated by a first processing temperature in a range between 350° C. and 450° C. in the first heating stage, and is subsequently treated by a second processing temperature in a range between 800° C. and 1,200° C. in the second heating stage.

Moreover, the present invention also provides an embodiment for the sodium-ion battery, which contains a negative electrode that is made of a biomass hard carbon, and the biomass hard carbon is manufactured by using the forgoing method.

In one embodiment of the forgoing sodium-ion battery, the biomass hard carbon further comprises an adhesive agent, and the adhesive agent is made of a material that is selected from the group consisting of carboxymethyl cellulose, styrene-butadiene rubber and polyvinylidene fluoride.

In one embodiment of the forgoing sodium-ion battery, the adhesive agent in the biomass hard carbon has a weight percent in a range between 10 and 15.

In summary, the present invention discloses a method of manufacturing a biomass hard carbon for use in a negative electrode of a sodium-ion battery. Differing from the fact that conventionally-used method for producing hard carbon is complex and certainly needs to synthesize a high cost precursor, the present invention makes a low cost precursor by mixing a nanoscale calcium carbonate powder with a biomass oil that is obtained by applying a thermochemical conversion process to a bio-waste. Particularly, carbon material containing in the biomass oil would be gathered and activated by a heating process because the biomass oil has a high oxygen content. Moreover, it is easily to modulate a pore size distribution of the biomass hard carbon by changing the weight percent of the nanoscale calcium carbonate powder. Consequently, in case of the biomass hard carbon being applied in the fabrication a specific battery like a sodium-ion battery or a lithium-ion battery, the specific battery would include the advantages of increasing reversible specific capacity, electrical conductivity of battery, low manufacturing cost, and keeping environmental protection.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a flowchart diagram of a method of manufacturing biomass hard carbon according to the present invention;

FIG. 2 shows an X-ray diffraction (XRD) spectra diagram of a biomass hard carbon fabricated by using the method of the present invention;

FIG. 3 shows a FE-SEM (Field emission scanning electron microscopy) image of the biomass hard carbon of the present invention;

FIG. 4 shows a first flowchart diagram of a method of manufacturing negative electrode of sodium-ion battery;

FIG. 5 shows a second flowchart diagram of a method of manufacturing negative electrode of sodium-ion battery; and

FIG. 6 shows a data graph for describing a cycle retention of the negative electrode.

### DETAILED DESCRIPTION OF THE PREFERRED EMBODIMENTS

To more clearly describe a method of manufacturing biomass hard carbon for use in negative electrode and a sodium-ion battery having the negative electrode, embodiments of the present invention will be described in detail with reference to the attached drawings hereinafter.

The present invention discloses a method of manufacturing a biomass hard carbon that is suitable for use in a negative electrode of a sodium-ion battery or a lithium-ion battery, wherein materials for making the biomass hard carbon comprises: carbon source, nanoscale power, acid solution, and pure water.

### Materials for Making the Biomass Hard Carbon

### Carbon Source

In the present invention, biomass oil is adopted for being as the carbon source, such as cracked oil and coke oil. It can easily obtain the carbon source by applying a thermochemical conversion process to a bio-waste like agricultural and forestry waste containing lignocellulos, and the thermochemical conversion process can be a carbonizing process, a pyrolysis process or a gasifying process. It is worth further explaining that, by applying a heating process to the biomass oil, carbon content in the biomass oil would be gathered and activated so as to form a hard carbon having higher interlayer spacing. In addition, the carbon source obtained by applying a thermochemical conversion process to the bio-waste includes the advantages of possessing high bio-energy density, low manufacturing cost, keeping environmental protection. For example, the said carbon source can be a by-product produced by a biomass multifuel gasifier, wherein the by-product is a biomass oil.

### Nanoscale Powder

In the present invention, material selected from the group consisting of calcium carbonate, zinc oxide, iron oxide, calcium phosphate, and a combination of the forgoing two or more materials is adopted for being as the nanoscale powder. For example, nanoscale calcium carbonate (CaCO₃) powder and the forgoing biomass oil are mixed to form a low cost precursor in order to subsequently producing a biomass hard carbon. In one embodiment, the nanoscale power in the precursor has a weight percent in a range between 0 and 50, and the nanoscale power comprising a plurality of nanoparticles having a particle size in a range between 20 nm and 80 nm. According to the particular design of the present invention, it is easily to modulate a pore size distribution of the biomass hard carbon by changing the weight percent of the nanoscale powder, such that the interlayer spacing of the biomass hard carbon is also varied with the changing the weight percent of the nanoscale powder. In a practicable embodiment, the said interlayer spacing is in a range between 0.343 nm and 0.41 nm. Therefore, it is understood that the interlayer spacing of the biomass hard carbon of the present invention is greater than that of graphite. As such, in case of the biomass hard carbon being applied in the fabrication a specific battery like a sodium-ion battery or a lithium-ion battery, the specific battery would include the advantages of increasing reversible specific capacity, electrical conductivity of battery, low manufacturing cost, and keeping environmental protection.

### Acid Solution

In the present invention, HCl is adopted for being as the acid solution, such that the nanoscale powder is easily solved in the HCl, thereby removing some residual materials and/or impurities from the nanoscale powder.

### Pure Water

In the present invention, the pure water is a deionized (DI) water for use in removing residual ions from the biomass hard carbon.

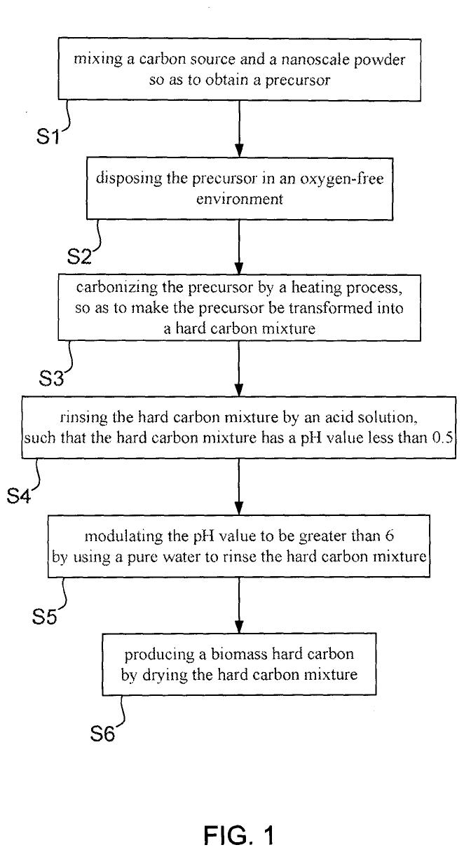

Above descriptions have introduced the composition of the biomass hard carbon of the present invention clearly. Next, a method of manufacturing biomass hard carbon proposed by the present invention will be subsequently described in following paragraphs. With reference to FIG. 1, there is shown a flowchart diagram of the method of manufacturing biomass hard carbon according to the present invention.

As FIG. 1 shows, the method flow is firstly proceeded to step S1, so as to obtain a precursor by mixing a carbon source and a nanoscale powder. In one practicable embodiment, biomass oil is adopted for being as the carbon source, such as cracked oil and coke oil. Moreover, it can easily obtain the carbon source by applying a thermochemical conversion process to a bio-waste like agricultural and forestry waste containing lignocellulos, and the thermochemical conversion process can be a carbonizing process, a pyrolysis process or a gasifying process. For example, the said carbon source can be a by-product produced by a biomass multifuel gasifier, wherein the by-product is a biomass oil. On the other hand, the nanoscale power is material that is selected from the group consisting of calcium carbonate, zinc oxide, iron oxide, calcium phosphate, and a combination of the forgoing two or more materials.

The method flow is subsequently proceeded to step S2, so as to dispose the precursor in an oxygen-free environment. It is worth explaining that, to dispose the precursor in an oxygen-free environment is helpful in preventing from the combustion of the hard carbon that is contained in the precursor.

As FIG. 1 shows, the method flow is next proceeded to step S3, so as to carbonize the precursor by a heating process, so as to make the precursor be transformed into a hard carbon mixture. According to the particular design of the present invention, the heating process comprises a first heating stage and a second heating stage, such that the precursor is treated by a first processing temperature in a range between 350° C. and 450° C. in a time interval of the first heating stage, and is subsequently treated by a second processing temperature in a range between 800° C. and 1,200° C. in a time interval of the second heating stage.

It is worth noting that, before starting to execute step S4 of the method flow, it needs to apply a grinding process to the hard carbon mixture. As such, during the execution of step S4, the hard carbon mixture is rinsed by an acid solution, so as to make the hard carbon mixture have a pH value less than 0.5. The forgoing acid solution can be exemplarily a hydrochloric acid (HCl) solution.

Furthermore, in step S5 of the method flow, it modulates the pH value to be greater than 6 by using a pure water to rinse the hard carbon mixture. In the present invention, the pure water is a deionized (DI) water for use in removing residual ions from the biomass hard carbon.

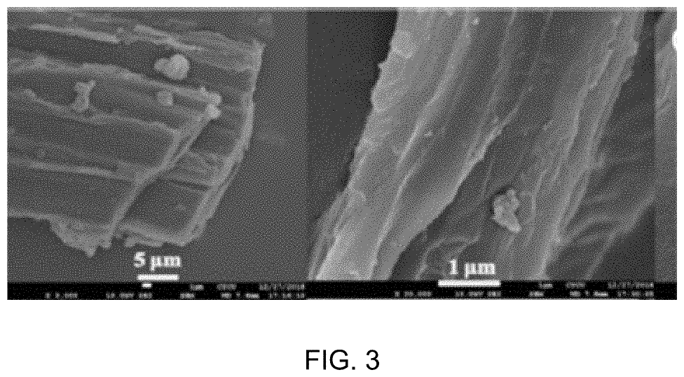

Consequently, the method flow is proceeded to step S6, so as to produce a biomass hard carbon by drying the hard carbon mixture. FIG. 3 shows a FE-SEM (Field emission scanning electron microscopy) image of the biomass hard carbon that is produced by using the method of the present invention.

Several embodiments (samples) of the biomass hard carbon of the present invention are introduced in following paragraphs. However, the embodiments are not intended to limit scope of the present invention, and all equivalent implementations or alterations within the spirit of the present invention still fall within the scope of the present invention.

### Embodiment I

For making the embodiment I of the biomass hard carbon, a cracked biomass oil and a nanoscale calcium carbonate (CaCO₃) powder is mixed in a blender by a mixing ratio of 1:1, thereby forming a precursor. The precursor is subsequently heated in an oxygen-free environment by a processing temperature in a range between 350° C. and 450° C. for 1 hour, so as to make the precursor be carbonized, thereby obtaining a hard carbon mixture. Continuously, the hard carbon mixture is heated in the oxygen-free environment by a processing temperature of 900° C. for 4 hour. After being cooled to room temperature, a hard carbon mixture is applied with a grinding process, and then is rinsed by HCl. Consequently, after using a pure water to modulate the pH value of the hard carbon mixture, the hard carbon mixture having the pH value greater than 6 is dried, thereby obtaining an embodiment I of the biomass hard carbon of the present invention. It is able to know that the embodiment I of the biomass hard carbon has an interlayer spacing of 0.41 nm through a HRTEM image. The term HRTEM means High Resolution Transmission Electron Microscope.

### Embodiment II

In order to complete the fabrication of the embodiment II of the biomass hard carbon, a coke oil and a nanoscale calcium carbonate (CaCO₃) powder is mixed in a blender by a mixing ratio of 1:1, thereby forming a precursor. The precursor is subsequently heated in an oxygen-free environment by a processing temperature in a range between 350° C. and 450° C. for 1 hour, so as to make the precursor be carbonized, thereby obtaining a hard carbon mixture. Continuously, the hard carbon mixture is heated in the oxygen-free environment by a processing temperature of 900° C. for 4 hour. After being cooled to room temperature, a hard carbon mixture is applied with a grinding process, and then is rinsed by HCl. Consequently, after using a pure water to modulate the pH value of the hard carbon mixture, the hard carbon mixture having the pH value greater than 6 is dried, thereby obtaining an embodiment II of the biomass hard carbon of the present invention. It is able to know that the embodiment II of the biomass hard carbon has an interlayer spacing of 0.41 nm through a HRTEM image.

### Embodiment III

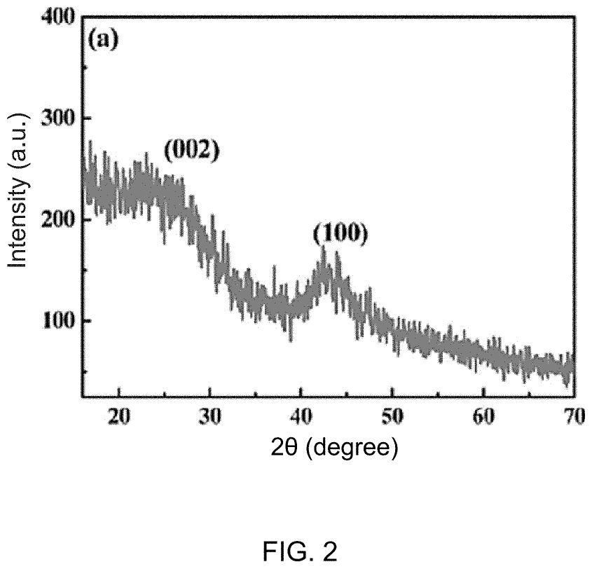

For making the embodiment III of the biomass hard carbon, a coke oil is adopted for being as a precursor. The precursor is subsequently heated in an oxygen-free environment by a processing temperature in a range between 350° C. and 450° C. for 1 hour, so as to make the precursor be carbonized, thereby obtaining a hard carbon. Continuously, the hard carbon is heated in the oxygen-free environment by a processing temperature of 900° C. for 4 hour. After being cooled to room temperature, a hard carbon is applied with a grinding process, and then is rinsed by HCl. Consequently, after using a pure water to modulate the pH value of the hard carbon, the hard carbon having the pH value greater than 6 is dried, thereby obtaining an embodiment III of the biomass hard carbon of the present invention. It is able to know that the embodiment III of the biomass hard carbon has a XRD peak intensity at 2θ=24° and 2θ=43° from the X-ray diffraction (XRD) spectra diagram of FIG. 2. As a result, measurement data have revealed that, the embodiment III of the biomass hard carbon of the present invention does not contain impurities, and has an interlayer spacing of 0.343 nm.

### Embodiment IV

In order to complete the fabrication of the embodiment IV of the biomass hard carbon, a cracked biomass oil is adopted for being as a precursor. The precursor is subsequently heated in an oxygen-free environment by a processing temperature in a range between 350° C. and 450° C. for 1 hour, so as to make the precursor be carbonized, thereby obtaining a hard carbon. Continuously, the hard carbon is heated in the oxygen-free environment by a processing temperature of 900° C. for 4 hour. After being cooled to room temperature, a hard carbon is applied with a grinding process, and then is rinsed by HCl. Consequently, after using a pure water to modulate the pH value of the hard carbon, the hard carbon having the pH value greater than 6 is dried, thereby obtaining an embodiment IV of the biomass hard carbon of the present invention.

Moreover, the present invention also provides an embodiment for the sodium-ion battery, which contains a negative electrode that is made of a biomass hard carbon, and the biomass hard carbon is manufactured by using the forgoing method. Embodiments of the sodium-ion battery of the present invention are introduced in following paragraphs. However, the embodiments are not intended to limit scope of the present invention, and all equivalent implementations or alterations within the spirit of the present invention still fall within the scope of the present invention.

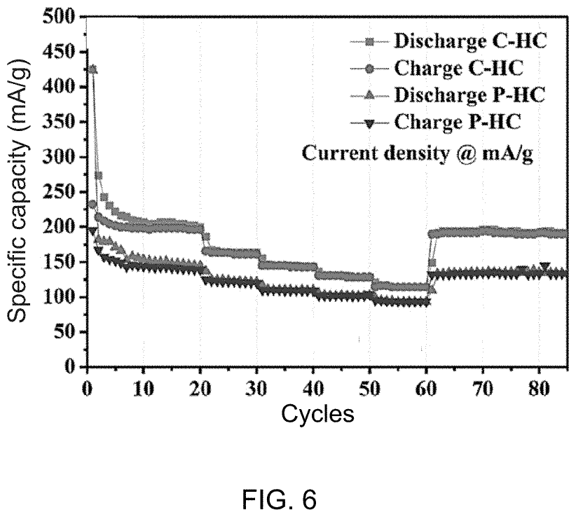

In one embodiment, the biomass hard carbon for making the negative electrode further comprises an adhesive agent, and the adhesive agent is made of a material that is selected from the group consisting of carboxymethyl cellulose, styrene-butadiene rubber and polyvinylidene fluoride. For example, the negative electrode made of the biomass hard carbon containing 10-15 wt % carboxymethyl cellulose or polyvinylidene fluoride is helpful in facilitating the sodium-ion battery includes advantages of high electricity capacity and long battery life. FIG. 6 shows a data graph for describing a cycle retention of the negative electrode. In FIG. 6, “C—HC” means that the negative electrode made of the biomass hard carbon contains an adhesive agent of carboxymethyl cellulose, and “P—HC” means that the negative electrode made of the biomass hard carbon contains an adhesive agent of polyvinylidene fluoride. Obviously, measurement data of FIG. 6 reveal that, the negative electrode containing the adhesive agent of carboxymethyl cellulose shows a specific capacity (mA/g) that is greater than the specific capacity of the negative electrode containing the adhesive agent of polyvinylidene fluoride. In addition, from measurement data of FIG. 6, it is also understood that, the negative electrode containing the adhesive agent and the biomass hard carbon of the present invention still has a steady structure in spited of being subject to a few times of charge and discharge cycle.

### Embodiment V

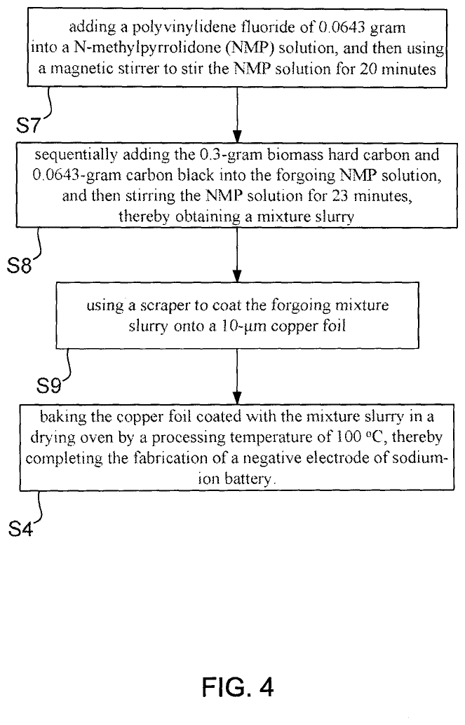

FIG. 4 shows a first flowchart diagram of a method of manufacturing a negative electrode of sodium-ion battery. As FIG. 4 shows, the method flow is firstly proceeded to step S7, so as to adding a polyvinylidene fluoride of 0.0643 gram into a N-methylpyrrolidone (NMP) solution, and then using a magnetic stirrer to stir the NMP solution for 20 minutes for making the polyvinylidene fluoride be fully solved in the NMP solution. Next, the method flow is proceeded to step S8, sequentially adding the 0.3-gram biomass hard carbon of the present invention and 0.0643-gram carbon black into the forgoing NMP solution, and then stirring the NMP solution for 30 minutes, thereby obtaining a mixture slurry. After that, in step S9, a scraper is used to coat the forgoing mixture slurry onto a 10-μm copper foil. Consequently, the method is proceeded to step S10, such that the copper foil coated with the mixture slurry thereon is baked in a drying oven by a processing temperature of 100° C., thereby completing the fabrication of a negative electrode of sodium-ion battery. As described in more detail below, the biomass hard carbon, the carbon black and the adhesive agent have a mixing ratio (w/w/w) of 70:15:15. Furthermore, the negative electrode mainly made of the biomass hard carbon, the carbon black and the adhesive agent is baked again under a 120° C. vacuum environment for 6 hours. After that, the negative electrode, a sodium-made counter electrode, a separator film, and an electrolyte are assembled to form a coin-like half-cell. It is worth explaining that, the electrolyte comprises a solution of 1M NaClO₄, a solvent of ethylene carbonate (EC), and a solvent of diethyl carbonate (DEC), wherein the EC and the DEC have a mixing ratio (v/v) of 1:1.

### Embodiment VI

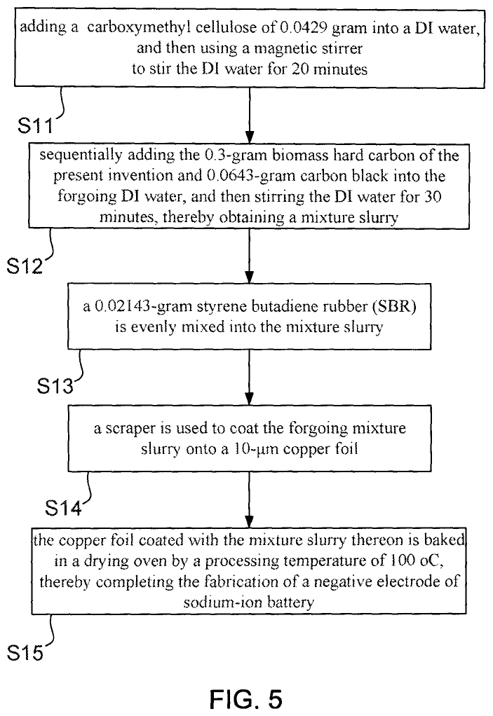

FIG. 5 shows a second flowchart diagram of the method of manufacturing the negative electrode of sodium-ion battery. As FIG. 5 shows, the method flow is firstly proceeded to step S11, so as to adding a carboxymethyl cellulose of 0.0429 gram into a DI water, and then using a magnetic stirrer to stir the DI water for 20 minutes for making the carboxymethyl cellulose be fully solved in the DI water. Next, the method flow is proceeded to step S12, sequentially adding the 0.3-gram biomass hard carbon of the present invention and 0.0643-gram carbon black into the forgoing DI water, and then stirring the DI water for 30 minutes, thereby obtaining a mixture slurry. After that, a 0.02143-gram styrene butadiene rubber (SBR) is evenly mixed into the mixture slurry in step S13, and then a scraper is used to coat the forgoing mixture slurry onto a 10-μm copper foil in step S14. Consequently, the method is proceeded to step S15, such that the copper foil coated with the mixture slurry thereon is baked in a drying oven by a processing temperature of 100° C., thereby completing the fabrication of a negative electrode of sodium-ion battery. As described in more detail below, the biomass hard carbon, the carbon black, the adhesive agent, and the SBR have a mixing ratio (w/w/w/w) of 70:15:10:5. Furthermore, the negative electrode mainly made of the biomass hard carbon, the carbon black and the adhesive agent is baked again under a 120° C. vacuum environment for 6 hours. After that, the negative electrode, a sodium-made counter electrode, a separator film, and an electrolyte are assembled to form a coin-like half-cell. It is worth explaining that, the electrolyte comprises a solution of 1M NaClO₄, a solvent of ethylene carbonate (EC), and a solvent of diethyl carbonate (DEC), wherein the EC and the DEC have a mixing ratio (v/v) of 1:1.

Through above descriptions, a method of manufacturing a biomass hard carbon that is suitable for use in fabrication of a negative electrode has been introduced clearly and completely. Differing from the fact that conventionally-used method for producing hard carbon is complex and certainly needs to synthesize a high cost precursor, the present invention makes a low cost precursor by mixing a nanoscale calcium carbonate (CaCO₃) powder with a biomass oil that is obtained by applying a thermochemical conversion process to a bio-waste. Moreover, it is easily to modulate a pore size distribution of the biomass hard carbon by changing the weight percent of the nanoscale calcium carbonate powder. Consequently, in case of the biomass hard carbon being applied in the fabrication a specific battery like a sodium-ion battery or a lithium-ion battery, the specific battery would include the advantages of increasing reversible specific capacity, electrical conductivity of battery, low manufacturing cost, and keeping environmental protection. The above description is made on embodiments of the present invention. However, the embodiments are not intended to limit scope of the present invention, and all equivalent implementations or alterations within the spirit of the present invention still fall within the scope of the present invention.

What is claimed is:

1. A method of manufacturing biomass hard carbon, comprising:
(1) mixing a carbon source and a nanoscale powder so as to obtain a precursor;
(2) disposing the precursor in an oxygen-free environment;
(3) carbonizing the precursor by a heating process, so as to make the precursor be transformed into a hard carbon mixture;
(4) rinsing the hard carbon mixture by an acid solution, such that the hard carbon mixture has a pH value less than 0.5;
(5) modulating the pH value to be greater than 6 by using a pure water to rinse the hard carbon mixture; and
(6) producing a biomass hard carbon by drying the hard carbon mixture.

2. The method of claim 1, wherein the carbon source is a bio-oil that is selected from the group consisting of cracked oil and coke oil.

3. The method of claim 2, wherein the carbon source is obtained by applying a thermochemical conversion process to a bio-waste, and the thermochemical conversion process is selected from the group consisting of carbonizing process, pyrolysis process and gasifying process.

4. The method of claim 1, wherein the nanoscale power is material that is selected from the group consisting of calcium carbonate, zinc oxide, iron oxide, calcium phosphate, and a combination of the forgoing two or more materials.

5. The method of claim 1, wherein the nanoscale power comprising a plurality of nanoparticles having a particle size in a range between 20 nm and 80 nm.

6. The method of claim 1, wherein the nanoscale power in the precursor has a weight percent in a range between 0 and 50.

7. The method of claim 1, wherein the heating process comprises a first heating stage and a second heating stage, such that the precursor is treated by a first processing temperature in a range between 350° C. and 450° C. in the first heating stage, and is subsequently treated by a second processing temperature in a range between 800° C. and 1,200° C. in the second heating stage.

8. The method of claim 1, wherein the biomass hard carbon is further processed to a negative electrode of a sodium-ion battery.

9. The method of claim 8, wherein an adhesive agent is added into the biomass hard carbon, and the adhesive agent is made of a material that is selected from the group consisting of carboxymethyl cellulose, styrene-butadiene rubber and polyvinylidene fluoride.

10. The method of claim 9, wherein the adhesive agent in the biomass hard carbon has a weight percent in a range between 10 and 15.
